(19) United States
(12) Patent Application Publication
(10) Pub. No.: US 2010/0028784 A1
(43) Pub. Date: Feb. 4, 2010

(54) ELECTROLYTE COMPOSITION, LITHIUM-CONTAINING ELECTROCHEMICAL CELL, BATTERY PACK, AND DEVICE INCLUDING THE SAME

(75) Inventors: Phat T. Pham, Little Canada, MN (US); William M. Lamanna, Stillwater, MN (US); Michael J. Bulinski, Houlton, WI (US); Douglas C. Magnuson, Woodbury, MN (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY

(21) Appl. No.: 12/181,625

(22) Filed: Jul. 29, 2008

(51) Int. Cl. H01M 6/16; H01M 10/26; H01M 2/10

(52) U.S. Cl. 429/332; 429/207; 429/100

(57) ABSTRACT

A nonflammable electrolyte composition comprises: a homogenous solvent mixture and a lithium salt dissolved therein. The homogenous solvent mixture comprises a cyclic carbonate and a highly fluorinated compound selected from the group consisting of highly fluorinated acyclic carbonates, CF₃CFHCF₂OCH₃, and combinations thereof. If the electrolyte composition has flammable constituents, they are present in a combined amount of less than 5 percent by weight. Lithium-containing electrochemical cells that include the electrolyte composition, and battery packs and devices including the same are also disclosed.

### FIELD

The present disclosure broadly relates to electrolyte compositions, lithium-containing electrochemical cells, batteries that include them, and devices including the batteries.

### BACKGROUND

The rapid development of electronic devices has increased market demand for electrochemical devices such as fuel cells and battery systems. In response to the demand for battery systems in particular, practical, rechargeable lithium batteries have been actively researched.

Lithium batteries (hereinafter the term “lithium batteries” includes both lithium ion batteries and lithium metal batteries) are particularly useful for many portable electronic devices such as, for example, cell phones, laptop computers, and camcorders. Lithium batteries employ highly chemically reactive components to provide electrical current. In operation, these systems are typically based on the use of lithium metal, lithiated carbon, or a lithium alloy as the negative electrode (anode) and electroactive transition metal oxides as the positive electrode (cathode). Lithium batteries are generally constructed from one or more electrochemical cells connected in parallel or series. Such cells have a non-aqueous lithium ion-conducting electrolyte composition interposed between electrically-separated and spatially-separated, positive and negative electrodes. The electrolyte composition is typically a liquid solution of a lithium salt in a nonaqueous, aprotic organic electrolyte solvent; typically, a mixture of two or more organic solvents.

The selection of electrolyte solvents for rechargeable lithium batteries is important for optimum battery performance and safety and involves a variety of different factors. However, long-term chemical stability in the presence of the charged positive and negative electrodes, ionic conductivity, safety, and wetting capability tend to be important selection factors in high volume commercial applications.

Long-term chemical stability requires that an electrolyte solvent be intrinsically stable over the battery's range of operating temperatures and voltages and also that it be either unreactive with electrode materials or that it contribute to effectively forming a passivating film with good ionic conductivity on the electrodes. Ionic conductivity requires an electrolyte solvent that effectively dissolves lithium electrolyte salts and facilitates lithium ion mobility. From the viewpoint of safety, the characteristics of low volatility, low flammability, low combustibility, low reactivity toward charged electrodes, passivating characteristics, and low toxicity are all highly desirable. It is also desirable that the battery's electrodes and separator be quickly and thoroughly wetted by the electrolyte solvent, so as to facilitate rapid battery manufacturing and optimize battery performance.

Aprotic liquid organic compounds have been the most commonly used electrolyte solvents used in lithium batteries. Often, compounds such as carbonic acid esters (carbonates) have been used, as these compounds typically share the desirable properties of low reactivity with the positive electrodes operating at less than about 4.4 volts (V) vs. Li⁺/Li, low reactivity with lithium-containing negative electrodes, and a thermodynamically favorable salvation interaction with lithium salts, which results in the electrolyte composition having a high ionic conductivity.

The most commonly used aprotic organic electrolyte solvents used in lithium batteries include: cyclic carbonates such as ethylene carbonate, propylene carbonate, and vinylene carbonate; cyclic esters of carboxylic acids such as γ-butyrolactone, linear carbonates such as dimethyl carbonate, diethyl carbonate and ethyl methyl carbonate; cyclic ethers such as 2-methyltetrahydrofuran and 1,3-dioxolane; linear ethers such as 1,2-dimethoxyethane; amides; and sulfoxides. A solvent mixture is often used in order to balance, or tailor, the desired properties of the electrolyte composition such as high dielectric constant and low viscosity.

Drawbacks to the use of conventional lithium battery electrolyte solvents are generally related to their properties such as low boiling points and high flammability or combustibility. For example, many electrolyte solvents have flash points less than 30.2° C. (100° F.). Such volatile solvents can ignite during catastrophic failure of a fully or partially charged battery that has undergone, for example, a rapid discharge due to a short circuit. Additionally, volatile electrolyte solvents present difficulties in the preparation and storage of electrolyte compositions as well as in the addition of the electrolyte composition to the battery during the manufacturing process. As if this weren't bad enough, many conventional battery electrolyte solvents are reactive towards charged electrodes at elevated temperatures, which can result in thermal runaway under abuse conditions.

### SUMMARY

In one aspect, the present disclosure provides an electrolyte composition comprising:

```
a solvent mixture comprising:
  at least one cyclic carbonate; and
  at least one highly fluorinated compound selected from the group
    consisting of highly fluorinated acyclic carbonates,
    CF₃CFHCF₂OCH₃, and combinations thereof; and
```

at least one lithium salt dissolved in the solvent mixture, wherein if the electrolyte composition has flammable constituents, they are present in a combined amount of less than 5 percent by weight, and wherein the electrolyte composition is homogeneous and not ignitable.

In another aspect, the present disclosure provides a lithium-containing electrochemical cell comprising a positive electrode, an electrolyte composition, and a negative electrode, wherein at least one of the positive electrode or the negative electrode comprises active lithium, and wherein the electrolyte composition comprises:

```
a solvent mixture comprising:
  at least one cyclic carbonate; and
  at least one highly fluorinated compound selected from the group
    consisting of highly fluorinated acyclic carbonates,
    CF₃CFHCF₂OCH₃, and combinations thereof; and
```

at least one lithium salt dissolved in the solvent mixture, wherein if the electrolyte composition has flammable constituents, they are present in a combined amount of less than 5 percent by weight, and wherein the electrolyte composition is homogeneous and not ignitable.

In some embodiments, the at least one cyclic carbonate is nonfluorinated. In some embodiments, the electrolyte composition is homogeneous. In some embodiments, the atomic ratio of F atoms to all monovalent atoms combined in the highly fluorinated compound is at least 0.5.

In some embodiments, the lithium salt comprises lithium bis(nonafluorobutanesulfonyl)imide, lithium bis(oxalato)borate, LiN(SO₂CF₃)₂, LiN(SO₂C₂F₅)₂, LiAsF₆, LiC(SO₂CF₃)₃, LiB(C₆H₅)₄, LiO₃SCF₃, LiPF₆, LiAsF₆, LiBF₄, LiClO₄, LiCl, LiBr, or a combination thereof.

In some embodiments, the cyclic carbonate comprises a fluorinated cyclic carbonate represented by the formula:

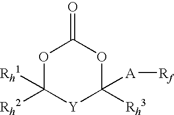

wherein:

each of Rₕ¹, Rₕ², and Rₕ³ is independently hydrogen or CₓH₂ₓ₊₁, wherein x is an integer from 1 to 4;

Y is a single covalent bond or —CRₕ⁴Rₕ⁵—, wherein each of Rₕ⁴ and Rₕ⁵ is independently a hydrogen or an alkyl group having 1 to 4 carbon atoms;

A is a single covalent bond or CH₂O; and

R_{f} is —CFR_{f}¹CHFR_{f}², wherein R_{f}¹ is F, or CₖF₂ₖ₊₁, and k is an integer from 1 to 8; and wherein R_{f}² is F, a linear or branched CₚF₂ₚ₊₁, wherein p is an integer from 1 to 4, or R_{f}³O(R_{f}⁴O)_{m—}, wherein m is 0 or 1, and wherein R_{f}³ is CₙF₂ₙ₊₁, and n is an integer from 1 to 8, and R_{f}⁴ is C_{q}F_{2q}, wherein q is an integer from 1 to 4, provided that when R_{f}¹ is F and R_{f}² is F, then at least one of Rₕ¹, Rₕ² and Rₕ³ is CₓH₂ₓ₊₁.

In some embodiments, the at least one cyclic carbonate comprises 4-(1,1,2,3,3,3-hexafluoropropyl)-1,3-dioxolan-2-one, 4-(1,1,2,3,3,3-hexafluoropropoxy)methyl)-1,3-dioxolan-2-one, or a combination thereof. In some embodiments, the at least one cyclic carbonate comprises 4,4-difluoro-1,3-dioxolan-2-one, 4-trifluoromethyl-1,3-dioxolan-2-one, fluoromethyl-1,3-dioxolan-2-one, 1′,1′,2′,2′-tetrafluoroethyl-1,3-dioxolan-2-one, or a combination thereof. In some embodiments, the at least one cyclic carbonate comprises ethylene carbonate, propylene carbonate, vinylene carbonate, vinylethylene carbonate, fluoroethylene carbonate, or a combination thereof.

In some embodiments, the at least one highly fluorinated compound is selected from the group consisting of CF₃CFHCF₂CH₂OC(═O)OCH₃, HCF₂CF₂CH₂OC(═O)OCH₃, CF₃CFHCF₂CH₂OC(═O)OC₂H₅, CF₃CH₂OC(═O)OCH₂CF₃, (CF₃CFHCF₂CH(CH₃)O)₂C═O, CF₃CFHCF₂OCH₃, combinations thereof.

In another aspect, a battery pack comprises a plurality of lithium-containing electrochemical cells according to the present disclosure.

Battery packs according to the present disclosure are useful, for example, in various devices that comprise a battery pack. In some embodiments, the battery pack is electrically coupled to an electric motor or an electronic display.

Advantageously, electrolyte compositions according to the present disclosure are not ignitable. Typically, they have low viscosity, and high electrolyte solubility, and if used in a battery pack comprising lithium-containing electrochemical cells, typically exhibit good electrode compatibility.

As used herein:

“active lithium” refers to lithium that takes part in an electrochemical reaction when a lithium-containing electrochemical cell is charged or discharged;

“flammable” means having a closed cup flash point of less than 140° F. (37.8° C.) (e.g., according to at least one of ASTM No. D3278-96 (2004)e1 “Standard Test Methods for Flash Point of Liquids by Small Scale Closed-Cup Apparatus” or D7236-06 (2006) “Standard Test Method for Flash Point by Small Scale Closed Cup Tester (Ramp Method)”;

“fluoroaliphatic group” means an aliphatic group, wherein at least one H atom is replaced by an F atom;

“highly fluorinated” means that the atomic ratio of F atoms to all monovalent atoms in a compound taken together is at least 0.4;

“ignitable” means failing the Ignition Test in the Examples section hereinbelow;

“low viscosity” means readily flowable (e.g., having a viscosity of less than 1500, 1000, 500, 100, 50, or even less than 10 millipascal-seconds (i.e., centipoise);

“nonaqueous” means free of other than adventitious water;

“nonflammable” means not flammable; and

the modifier “(s)” means “one or more”.

### BRIEF DESCRIPTION OF THE DRAWING

FIG. 1 is an exploded perspective view of an exemplary lithium-containing electrochemical cell.

### DETAILED DESCRIPTION

Electrolyte compositions according to the present disclosure include a homogenous solvent mixture and lithium salt(s). Viscosity is typically an important factor in achieving high electrolyte conductivity (e.g., high lithium ion mobility). Accordingly, the electrolyte composition typically is of low viscosity, although more viscous electrolyte compositions may also be used.

The homogenous solvent mixture comprises cyclic carbonate(s) and highly fluorinated compound(s). Typically, the cyclic carbonate(s) have high dielectric constants important for salt dissolution and ion dissociation. This is important for achieving high ionic conductivity, but this also leads to high viscosity in the liquid state. The cyclic carbonates are also generally high boiling and classified as nonflammable. In contrast, the highly fluorinated compound(s) are typically relatively low viscosity liquids, and are typically useful for reducing the viscosity of the electrolyte solution. Moreover, their high fluorine content may provide non-flammability. In many conventional Li-ion battery electrolytes, non-fluorinated solvents such as diethyl carbonate, dimethyl carbonate or ethyl methyl carbonate are used for this purpose, but such solvents are typically flammable and contribute to the flammability of electrolytes containing them.

The cyclic carbonate(s) may be non-fluorinated or fluorinated (including highly fluorinated). Exemplary commercially available non-fluorinated cyclic carbonate(s) include ethylene carbonate, propylene carbonate, butylene carbonate, vinylene carbonate, vinylethylene carbonate, and combinations thereof Exemplary fluorinated cyclic carbonate(s) include fluoroethylene carbonate (e.g., as available from Synquest Labs, Alachua, Fla.), 4-fluoromethyl-1,3-dioxolan-2-one (e.g., as described by W. N. Sit, et al., J. Org. Chem. (2005), vol. 70(21), p. 8583-8586), and highly fluorinated cyclic carbonates. Examples of highly fluorinated cyclic carbonate(s) include 4-(1,1,2,3,3,3-hexafluoropropyl)-1,3-dioxolan-2-one, 4-(1,1,2,3,3,3-hexafluoropropoxy)methyl)-1,3-dioxolan-2-one, 4,5-difluoro-1,3-dioxolan-2-one, 4-trifluoromethyl-1,3-dioxolan-2-one (e.g., as available from Matrix Scientific, Columbia, S.C.), 4-(1′,1′,2′,2′-tetrafluoroethyl)-1,3-dioxolan-2-one, and combinations thereof. Additional examples include fluorinated cyclic carbonate(s) represented by the formula:

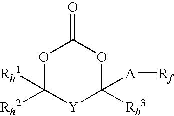

wherein:

each of Rₕ¹, Rₕ² and Rₕ³ is independently hydrogen or CₓH₂ₓ₊₁, wherein x is an integer from 1 to 4;

Y is a single covalent bond or —CRₕ⁴Rₕ⁵—, wherein each of Rₕ⁴ and Rₕ⁵ is independently a hydrogen or an alkyl group having 1 to 4 carbon atoms;

A is a single covalent bond or CH₂O; and

R_{f} is —CFR_{f}¹CHFR_{f}², wherein R_{f}¹ is F, or CₖF₂ₖ₊₁, and k is an integer from 1 to 8; and wherein R_{f}² is F, a linear or branched CₚF₂ₚ₊₁, wherein p is an integer from 1 to 4, or R_{f}³O(R_{f}⁴O)_{m—}, wherein m is 0 or 1, and wherein R_{f}³ is CₙF₂ₙ₊₁, and n is an integer from 1 to 8, and R_{f}⁴ is C_{q}F_{2q}, wherein q is an integer from 1 to 4, provided that when R_{f}¹ is F and R_{f}² is F, then at least one of Rₕ¹, Rₕ² and Rₕ³ is CₓH₂ₓ₊₁. The synthesis of highly fluorinated cyclic carbonates is described in PCT Publ. No. WO 2008/079670 A1 (Lamanna et al.).

The cyclic carbonate(s) and highly fluorinated compound(s) are typically not polymeric, but this is not a requirement.

The highly fluorinated compound is selected from the group consisting of highly fluorinated acyclic carbonates, CF₃CFHCF₂OCH₃, and combinations thereof While the highly fluorinated compound has an atomic ratio of F atoms to all monovalent atoms combined in a compound is at least 0.4, it may be at least 0.5, at least 0.6, or even higher. Exemplary highly fluorinated compounds include: acyclic carbonates such as HCF₂CF₂CH₂OC(═O)OCH₃, CF₃CFHCF₂CH₂OC(═O)OCH₃, CF₃CFHCF₂CH₂OC(═O)OC₂H₅, CF₃CH₂OC(═O)OCH₂CF₃, and (CF₃CFHCF₂CH(CH₃)O)₂C═O; CF₃CFHCF₂OCH₃; and combinations thereof.

The hydrofluoroether CF₃CFHCF₂OCH₃ may be included in the at least one highly fluorinated compound. It is commercially available, for example, from Fluorochem Ltd., Derbyshire, United Kingdom.

Optionally additional hydrofluoroethers may be further included in the electrolyte composition; examples include CF₃CFHCF₂OC₂H₅, CF₃CFHCF₂OCH₂CH(CH₃)OCF₂CFHCF₃, CF₃CFHCF₂OCH₂CH₂OCF₂CFHCF₃, CF₃CFHCF₂CH₂OCF₂CFHCF₃, CF₃CFHCF₂CH₂OCF₂CF₂H, HCF₂CF₂CH₂OCF₂CF₂H, H(CF₂CF₂)₂CH₂OCF₂CFHCF₃, HCF₂CF₂CH₂OCF₂CFHCF₃, H(CF₂CF₂)₂CH₂OCF₂CF₂H, H(CF₂CF₂)₃CH₂OCF₂CFHCF₃, HCF₂CF₂CH₂OCH₂CF₂CF₂H, CF₃CFHCF₂CH(CH₃)OCF₂CFHCF₃ (available as NOVEC ENGINEERED FLUID HFE-7600 from 3M Company), C₄F₉OCH₃ (available as NOVEC ENGINEERED FLUID HFE-7100 from 3M Company), C₄F₉OC₂H₅ (available as NOVEC ENGINEERED FLUID HFE-7200 from 3M Company), C₆F₁₃OCH₃ (available as NOVEC ENGINEERED FLUID HFE-7300 from 3M Company), C₇F₁₅OC₂H₅ (available as NOVEC ENGINEERED FLUID HFE-7500 from 3M Company), CF₃CH₂OCF₂CF₂H (available as AE3000 from Asahi Glass, Ltd., Tokyo, Japan), other highly fluorinated ethers described in U.S. Pat. Appl. Publ. No. 2007/0051916 A1 (Flynn) and U.S. Pat. No. 5,925,611 (Flynn et al.), and combinations thereof.

Highly fluorinated acyclic carbonates can be prepared by methods well known in the art; for example, by the reaction of fluorinated alcohols with phosgene (or phosgene equivalents such as triphosgene) or with alkyl chloroformates as described in PCT Publ. No. WO 2008/079670 (Lamanna et al.) and in U.S. patent application Ser. No. 12/018,285 (Bulinski et al.), filed Jan. 23, 2008.

Highly fluorinated ethers are readily prepared by art known methods as described in U.S. Pat. Appln. Publ. No. 2007/0051916 A1 (Flynn et al.) and U.S. Pat. No. 5,925,611 (Flynn et al.).

Any amount of cyclic carbonate and highly fluorinated compound may be used, subject to the limitations on the amount of any flammable constituent(s) that may be present.

Lithium salt(s) may be organic or inorganic, and should generally be selected so that they do not appreciably degrade during use in a lithium battery. Exemplary lithium salt(s) include lithium bis(nonafluorobutanesulfonyl)imide, lithium bis(oxalato)borate, LiN(SO₂CF₃)₂, LiN(SO₂C₂F₅)₂, LiAsF₆, LiC(SO₂CF₃)₃, LiB(C₆H₅)_{4, LiO}₃SCF₃, LiPF₆, LiAsF₆, LiBF₄, LiClO₄, LiCl, LiBr, and combinations thereof.

The electrolyte composition may contain one or more optional constituents such as, for example: non-aqueous co-solvents such as, for example, diethyl carbonate, dimethyl carbonate, ethyl methyl carbonate, 1,2-dimethoxyethane, 1,2-diethoxyethane, gamma-butyrolactone, valerolactone, tetrahydrofuran, 2-methyltetrahydrofuran, 1,3-dioxolane, 4-methyl-1,3-dioxolane, sulfolane, methylsulfolane, and combinations thereof, and other additives that will be familiar to those skilled in the art. For example, the electrolyte may contain a redox chemical shuttle such as those described in U.S. Pat. No. 5,709,968 (Shimizu), U.S. Pat. No. 5,763,119 (Adachi), U.S. Pat. No. 5,536,599 (Alamgir et al.), U.S. Pat. No. 5,858,573 (Abraham et al.), U.S. Pat. No. 5,882,812 (Visco et al.), U.S. Pat. No. 6,004,698 (Richardson et al.), U.S. Pat. No. 6,045,952 (Kerr et al.), and U.S. Pat. No. 6,387,571 B1 (Lain et al.); and in U.S. Pat. Appl. Publ. Nos. 2005/0221168 A1, 2005/0221196 A1, 2006/0263696 A1, and 2006/0263697 A1 (all to Dahn et al.). The amount of optional constituent(s) is typically not larger than 40% by volume of the electrolyte composition, more typically not larger than 20% by volume, and of course limits on the total amount of flammable constituents should not be exceeded.

While the amount of flammable constituents may be up to 5 percent by weight of the electrolyte composition, it is desirably less than 2, 1, or 0.1 percent by weight, or even less.

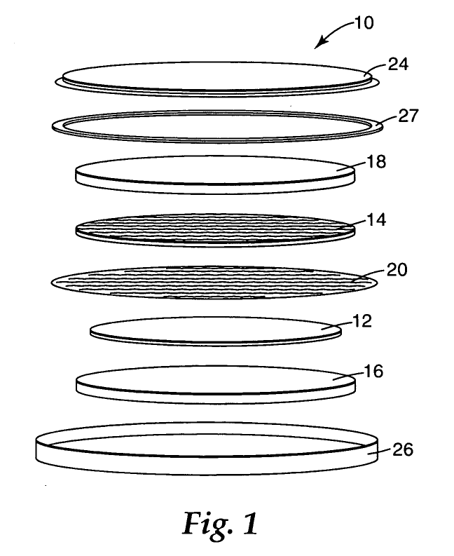

Electrolyte compositions are useful, for example, in a lithium-containing electrochemical cell. FIG. 1 shows a representative lithium-containing electrochemical cell in the form of a coin cell (falling within the meaning of the term “battery pack” as used herein), although many other cell and/or battery pack types are within the skill of those in the art. Referring now to FIG. 1, coin cell 10 has stainless steel cap 24 and oxidation resistant case 26 that contain the cell and serve as the negative and positive terminals, respectively. Aluminum spacer plate 16 is disposed behind the cathode 12 and copper spacer plate 18 behind lithium foil anode 14. Separator 20 is wetted with the electrolyte composition (not shown). Gasket 27 seals and separates the two terminals, for example, upon pressing of the assembled component parts of the coin cell. The art is replete with materials useful for the cathode and anode, and the specific selection is within the skill of one in the art.

Lithium-containing electrochemical cells may be made, for example, by taking at least one each of a positive electrode and a negative electrode as described above and placing them in an electrolyte. Typically, a microporous separator, such as CELGARD 2400 microporous material, available from Celgard, Charlotte, N.C., may be used to prevent the contact of the negative electrode directly with the positive electrode. Lithium-containing electrochemical cells made with the provided negative electrodes and binders showed reduced irreversible capacity loss and less fade than similar cells containing negative electrodes with conventional binders.

The positive electrode (cathode) may be made from an electrode composition including, for example, LiCo_{0.2}Ni_{0.8}O₂, LiNiO₂, LiFePO₄, LiMnPO₄, LiCoPO₄, LiMn₂O₄, LiCoO₂, LiNi_{0.5}Mn_{1.5}O₄, LiVPO₄F; mixed metal oxides of cobalt, manganese, and nickel such as those described in U.S. Pat. No. 6,964,828 B2 (Lu et al.) and U.S. Pat. No. 7,078,128 B2 (Lu et al.); and nanocomposite cathode compositions such as those described in U.S. Pat. No. 6,680,145 B2 (Obrovac et al.). Typically, the foregoing compositions are combined (e.g., using pressure) with a binder and optional additional additives such as will be familiar to those skilled in the art.

For example, the electrode composition may include an electrically conductive diluent to facilitate electron transfer from the powdered material to a current collector. Electrically conductive diluents include, but are not limited to, carbon (e.g., carbon black for negative electrodes and carbon black, flake graphite and the like for positive electrodes), metal, metal nitrides, metal carbides, metal silicides, and metal borides. Representative electrically conductive carbon diluents include carbon blacks such as SUPER P and SUPER S carbon blacks (both from MMM Carbon, Belgium), SHAWANIGAN BLACK (Chevron Chemical Co., Houston, Tex.), acetylene black, furnace black, lamp black, graphite, carbon fibers, single-walled carbon nanotubes, multiple-walled carbon nanotubes, and combinations thereof.

The electrode composition may include an adhesion promoter that promotes adhesion of the powdered material or electrically conductive diluent to the binder. The combination of an adhesion promoter and binder may help the electrode composition better accommodate volume changes that may occur in the powdered material during repeated lithiation/delithiation cycles. The provided binders may offer sufficiently good adhesion to metals, alloys and metal oxides so that addition of an adhesion promoter may not be needed. If used, an adhesion promoter may be made a part of the binder (e.g., in the form of an added functional group), may be a coating on the powdered material, may be added to the electrically conductive diluent, or may be a combination of such measures. Examples of adhesion promoters include silanes, titanates, and phosphonates as described in U.S. Pat. No. 7,341,804 B2 (Christensen).

Provided binders include lithium polysalts. Lithium polysalts include lithium polyacrylates (including polymethacrylates), lithium polystyrenesulfonates, and lithium polysulfonate fluoropolymers. The lithium polysalts are available from the corresponding acrylic or sulfonic acids by neutralization of the acidic groups with basic lithium. Commonly lithium hydroxide is used to neutralize acid groups. It is also within the scope of this application to replace other cations, such as sodium, with lithium by ion exchange. For example, an ion exchange resin such as available as DIANION SKT10L from Mitsubishi Chemical, Tokyo, Japan, may be used to exchange sodium ion for lithium ion.

The negative electrode (anode) may be made from compositions that include lithium, carbonaceous materials, silicon alloy compositions and lithium alloy compositions. Exemplary carbonaceous materials may include synthetic graphites such as mesocarbon microbeads (MCMB) (available from E-One Moli/Energy Canada Ltd., Vancouver, BC), SLP30 (available from TimCal Ltd., Bodio, Switzerland), natural graphites and hard carbons. Useful anode materials also include alloy powders or thin films. Such alloys may include electrochemically active components such as silicon, tin, aluminum, gallium, indium, lead, bismuth, and zinc and may also comprise electrochemically inactive components such as iron, cobalt, transition metal silicides and transition metal aluminides. Useful alloy anode compositions include alloys of tin or silicon such as Sn—Co—C alloys, Si₆₀Al₁₄Fe₈TiSn₇Mm₁₀ and Si₇₀Fe₁₀Ti₁₀C₁₀ where Mm is a Mischmetal (an alloy of rare earth elements). Metal alloy compositions used to make anodes may have a nanocrystalline or amorphous microstructure. Such alloys may be made, for example, by sputtering, ball milling, rapid quenching or other means. Useful anode materials also include metal oxides such as Li₄Ti₅O₁₂, WO₂, SiOₓ and tin oxides or metal sulphites, such as TiS₂ and MoS₂. Other useful anode materials include tin-based amorphous anode materials such as those disclosed in U.S. Pat. Appl. No. 2005/0208378 A1 (Mizutani et al.).

Exemplary silicon alloys that may be used to make suitable anodes include compositions that comprise from about 65 to about 85 mole percent silicon, from about 5 to about 12 mole percent iron, from about to about 12 mole percent titanium, and from about 5 to about 12 mole percent carbon. Additional examples of useful silicon alloys include compositions that include silicon, copper, and silver or silver alloy such as those discussed in U.S. Pat. Publ. No. 2006/0046144 A1 (Obrovac et al.); multiphase, silicon-containing electrodes such as those discussed in U.S. Pat. Publ. No. 2005/0031957 A1 (Christensen et al.); silicon alloys that contain tin, indium and a lanthanide, actinide element or yttrium such as those described in U.S. Pat. Appln. Publ. Nos. 2007/0020521 A1, 2007/0020522 A1, and 2007/0020528 A1 (all to Obrovac et al.); amorphous alloys having a high silicon content such as those discussed in U.S. Pat. Publ. No. 2007/0128517 A1 (Christensen et al.); and other powdered materials used for negative electrodes such as those discussed in U.S. Pat. Appln. Publ. No. 2007/0269718 A1 (Krause et al.) and PCT Publ. No. WO 2007/044315 A1 (Krause et al.). Anodes may also be made from lithium alloy compositions such as those of the type described in U.S. Pat. Nos. 6,203,944 B1 and 6,436,578 B2 (both to Turner et al.), and in U.S. Pat. No. 6,255,017 B1 (Turner).

Lithium-containing electrochemical cell(s) according to the present disclosure are useful, for example, for preparing a battery pack. The term battery pack refers to one or more lithium-containing electrochemical cells, which may be arranged in parallel, series, or a combination of the two.

Battery packs including electrolyte composition(s) according to the present disclosure may be used in a variety of devices, including, for example, portable computers, tablet displays, toys, personal digital assistants, mobile telephones, motorized devices (e.g., personal or household appliances and vehicles), instruments, illumination devices (e.g., flashlights) and heating devices.

Objects and advantages of this disclosure are further illustrated by the following non-limiting examples, but the particular materials and amounts thereof recited in these examples, as well as other conditions and, details, should not be construed to unduly limit this disclosure.

### EXAMPLES

Unless otherwise noted, all parts, percentages, ratios, etc. in the Examples and the rest of the specification are by weight. In the following examples “vol” means “volume”.

### Ignition Test

One milliliter of liquid material to be tested is placed into a 7.6-centimeter diameter glass Petri dish open to the atmosphere. The yellow portion of a flame from a butane lighter is placed at the surface of the material in the Petri dish. A material passes this test if it exhibits no sign of ignition (flame or flash) during 5 seconds. Any material that does not pass this test fails the test.

### Electrolyte Components

Ethylene carbonate (EC), Propylene carbonate (PC) and Diethyl carbonate, (DEC) were obtained from Ferro Corp., Cleveland, Ohio. Mono-fluoroethylene carbonate (FEC) was obtained from Fujian Chuangxin Science and Technology Develops, Fuzhou City, China. Vinylene carbonate (VC) was obtained from Jiangsu Guotai International Co., Zhangjiagang, China. Vinyl ethylene carbonate (VEC) and N-methylpyrrolidinone (NMP) are available from Aldrich Chemical Co., Milwaukee, Wis.

The following fluorinated solvents are available from 3M Company and/or can be prepared according to the general procedures set forth hereinabove: CF₃CFHCF₂CH₂OC(O)OCH₃, CF₃CFHCF₂CH₂OC(O)OC₂H₅, CF₃CH₂OC(O)OCH₂CF₃, CF₃CFHCF₂OCH₃, and

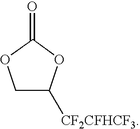

LiPF₆ electrolyte grade salt was obtained from Stella Chemifa Corporation, Osaka, Japan.

LiN(SO₂CF₃)₂ (LiTFSI) high purity salt is commercially available from 3M Company as HQ-115.

All solvents were battery grade with high purity and were dried over molecular sieves (3A (0.3 nm) type) before using. The standard electrolyte 1 molar LiPF₆ in ethylene carbonate: dimethyl carbonate: ethyl methyl carbonate (EC:DMC:EMC) (1:1:1) was obtained from Ferro Chemicals.

### Negative Electrode Preparation

A pre-mix (5.25 grams) of 0.137 grams of carbon black (available as SUPER P from Timcal Co., Ltd, Switzerland), 0.137 grams of polyvinylidene difluoride (PVDF) powder (available as KYNAR 741 from Arkema, Inc., King of Prussia, Pa.), 4.975 grams of N-methylpyrrolidinone (NMP), and 2.50 grams of graphite (mesocarbon microbeads (MCMB), available as MCMB, No. 6-10 from Osaka Gas. Co., Osaka-shi, Japan) was added to 2.5 grams of MCMB in a 50 ml vessel. The mixture was then rotated in a planetary mixer for 12 minutes. The mixture was coated on a copper foil using a 10 mils (0.25 mm) gap die coater. The coated foil was heated in an oven at 80° C. for 30 minutes and then dried at 120° C. under vacuum for 1 hour. The dried coated foil was stored in a dry-room until use.

### Positive Electrode Preparation

Li_{1.06}[Co_{0.33}Ni_{0.33}Mn_{0.33}]O₂ powder (90 parts, available from 3M Company as MNC-A) was mixed with pre-dispersed SUPER P carbon black (5 parts) in PVDF powder (5 parts, KYNAR 741) as a 10 percent solution in N-methylpyrolidinone. Mixing was done using a planetary mixer. The resulting solution was hand spread onto a 13-micrometer thick aluminum foil using a 10-mil (0.25 mm) gap die coater. The coated foil sample was heated in an air oven at 80° C. for 15 minutes, and then dried under vacuum at 120° C. for 1 hour.

Results of testing various electrolyte compositions are reported in Table 1 (below), wherein “vol” indicates volume.

TABLE 1

| | IGNITION |
|---|---|
| MATERIAL EVALUATED | TEST |
| 1 M LiPF₆/EC:DEC (1:2, vol:vol) | Fail |
| Control sample | |
| 1 molar LiPF₆/EC:DMC:EMC (1:1:1) | Fail |
| Control sample | |
| 1 molar LiPF₆ in | Pass |
| EC:PC:CF₃CFHCF₂CH₂OC(O)OCH₃:FEC | |
| (10:50:30:10, vol:vol:vol:vol) | |
| 1 molar LiPF₆ in | Pass |
| EC:PC:CF₃CFHCF₂CH₂OC(O)OC₂H₅:FEC | Pass |
| (10:50:30:10, vol:vol:vol:vol) | |
| 1 molar LiPF₆ in | Pass |
| PC:CF₃CFHCF₂CH₂OC(O)OC₂H₅ | |
| (50:50) | |
| 1 molar Li-TFSI in | Pass |
| FEC:CF₃CFHCF₂CH₂OC(O)OC₂H₅ | |
| (40:60) | |
| 1 molar LiPF₆ in | Pass |
| VC:CF₃CH₂OC(O)OCH₂CF₃ | Pass |
| (50:50) | |
| 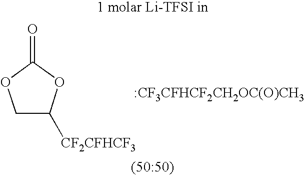 | Pass |
| 1 molar LiPF₆ in | Pass |
| EC:PC:CF3CFHCF2OCH3 | |
| (10:50:40, vol:vol:vol) | |
| 1 molar LiPF6 in | Pass |
| EC:PC:CF₃CFHCF₂OCH₃:FEC | |
| (10:50:30:10, vol:vol:vol:vol) | |
| 1 molar Li-TFSI in | Pass |
| PC:CF₃CFHCF₂OCH₃ | |
| (50:50) | |

### Coin Cell Preparation

Coin cells were prepared using 2325 button cells. All the components were dried prior to assembling and the cell preparations were done in a dry-room with a −70° C. dew point. Two types of coin cells were constructed from the following components, and in the following order, from the bottom up: (i) Cu plate/Li metal film/Separator (microporous polypropylene membrane available as CELGARD 2400 from Celgard, Inc., Charlotte, N.C.)/Electrolyte/Separator/MCMB composite electrode/Cu plate (Type 1 coin cell) and (ii) Cu plate/Li metal film/Separator/Electrolyte/Separator/MNC-A composite electrode/aluminum plate (Type 2 coin cell). An amount of 100 microliters of electrolyte was used to fill each cell. The cells were crimp sealed prior to testing.

Test Conditions for Li/MCMB Anode Coin cells

The cells were cycled from 0.005 to 0.9 volt at the rate of C/4 at room temperature using a battery test system. For each cycle, the cells were first discharged at a C/4 rate with a trickle current of 10 milliamps/gram at the end of discharge (delithiation) and then a rest for 15 minutes at open circuit. The cells were then charged at C/4 rate followed by another 15 minutes rest at open circuit. The cells were run through many cycles to determine the extent of capacity fade as a function of the number of cycles completed.

### Test Conditions for Li/MNC-A Cathode Coin Cells

The cells were charged and discharged between 4.3-2.5 volt at the rate of C/10 for the first formation cycle at room temperature using a battery test system from Maccor, Inc. After the first cycle the cells were then charged at 1C rate and discharged at C/4 rate for each cycle. The cells were run through many cycles to determine the extent of capacity fade as a function of the number of cycles completed.

### Coin Cell Performance

The cycling performance of Type 1 coin cells, charged at C/4 rate was evaluated for different two electrolytes:

The first electrolyte was 1 molar LiPF₆ in EC:DEC (1:2, vol:vol). The charge-discharge cycles the specific discharge capacity had faded from 300 milliamp-hours/gram at 2 cycles to 256 milliamp-hours/gram after 90 cycles.

The second electrolyte was 1 molar LiPF₆ in EC:PC:CF₃CFHCF₂OCH₃:FEC (10:50:30:10, vol:vol:vol:vol). The charge-discharge cycles the specific discharge capacity had faded from 302 milliamp-hours/gram at 2 cycles to 284 milliamp-hours/gram after 100 cycles.

The cycling performance of Type 2 coin cells, charged at C/4 rate was evaluated for different three electrolytes:

The first electrolyte was 1 molar LiPF₆ in EC:DEC (1:2, vol:vol). The charge-discharge cycles the specific discharge capacity had faded from 152 milliamp-hours/gram at 2 cycles to 147 milliamp-hours/gram after 70 cycles.

The second electrolyte was 1 molar LiPF₆ in EC:PC:CF₃CFHCF₂OCH₃ (10:50:40, vol:vol:vol). The charge-discharge cycles the specific discharge capacity had faded from 153 milliamp-hours/gram at 2 cycles to 148 milliamp-hours/gram after 70 cycles.

The third electrolyte was 1 molar LiPF₆ in EC:PC:CF₃CFHCF₂OCH₃:VC (10:50:30:10, vol:vol:vol:vol). The charge-discharge cycles the specific discharge capacity had faded from 141 milliamp-hours/gram at 2 cycles to 128 milliamp-hours/gram after 70 cycles.

### 18650 Cell Preparation

The electrodes used for 18650 cells were graphite anode and LiCoO₂ cathode. Both anode and cathode were coated on both sides of Cu and Al foils respectively by E-One Moli Energy (Canada), Ltd., Maple Ridge, BC, Canada. Their dimensions were 60 cm long×5.7 cm wide with 11.5 mg/cm² loading (for anode) and 57 cm long×5.5 cm wide with 28.52 mg/cm² loading (for cathode). The two electrodes were separated by a 25 micrometer CELGARD 2400 separator, and then wound to make a roll with about 1.72 cm diameter. The roll was inserted into an 18540 cell holder. The bottom electrical terminal tab was welded to the bottom the cell. The cell was filled with 6.0 g of electrolyte using vacuum filling technique. The cell was then sealed with the cap after it was welded to the top electrical terminal tab of the roll.

### 18650 Cell Test Procedure

The 18650 cells were cycled from 2.8 to 4.2 V at room temperature using a battery test system. For the first cycle, the cells were charged at a C/10 rate to 4.2 V, then allowed to rest for 1 hour at open circuit and then discharged at C/10 rate to 2.5 V followed by another 15 minutes rest at open circuit. Then the cells were charged and discharged at the rate of C/4, and allowed to rest at open circuit for 15 min. The cells were cycled many times to determine the extent of capacity fade as a function of the number of cycles completed.

### Example 1 and Comparative Example A (18650 Cell Performance)

Different 18650 cells using different electrolytes were prepared as in 18650 Cell Preparation (above), and were tested according to the 18650 Cell Test Procedure (above).

### Example 1

The electrolyte was 1 molar LiPF6 in EC:PC:CF₃CFHCF₂OCH₃:FEC (10:50:30:10, vol:vol:vol:vol). The charge-discharge cycles the specific discharge capacity had faded from 2082 milliamp-hours/gram at 1st cycle to 1911 milliamp-hours/gram after 100 cycles.

### Comparative Example A

The electrolyte was 1 molar LiPF₆ in EC:DMC:EMC (1:1:1). The charge-discharge cycles the specific discharge capacity had faded from 2158 milliamp-hours/gram at 1st cycle to 1855 milliamp-hours/gram after 100 cycles.

All patents and publications referred to herein are hereby incorporated by reference in their entirety. Various modifications and alterations of this disclosure may be made by those skilled in the art without departing from the scope and spirit of this disclosure, and it should be understood that this disclosure is not to be unduly limited to the illustrative embodiments set forth herein.

1. An electrolyte composition comprising:
a solvent mixture comprising:
at least one cyclic carbonate; and
CF₃CFHCF₂OCH₃; and
at least one lithium salt dissolved in the solvent mixture, wherein if the electrolyte composition has flammable constituents, they are present in a combined amount of less than 5 percent by weight, and wherein the electrolyte composition is homogeneous and not ignitable.

2. The electrolyte composition according to claim 1, wherein the at least one cyclic carbonate is nonfluorinated.

3. The electrolyte composition according to claim 1, wherein the at least one lithium salt comprises lithium bis(nonafluorobutanesulfonyl)imide, lithium bis(oxalato)borate, LiN(SO₂CF₃)₂, LiN(SO₂C₂F₅)₂, LiAsF₆, LiC(SO₂CF₃)₃, LiB(C₆H₅)₄, LiO₃SCF₃, LiPF₆, LiAsF₆, LiBF₄, LiClO₄, LiCl, LiBr, or a combination thereof.

4. The electrolyte composition according to claim 1, wherein the at least one cyclic carbonate comprises ethylene carbonate, propylene carbonate, vinylene carbonate, vinylethylene carbonate, fluoroethylene carbonate, or a combination thereof.

5. The electrolyte composition according to claim 1, wherein the at least one cyclic carbonate comprises a fluorinated cyclic carbonate represented by the formula: 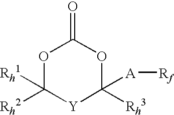
wherein:
each of Rₕ¹, Rₕ² and Rₕ³ is independently hydrogen or CₓH₂ₓ₊₁, wherein x is an integer from 1 to 4;
Y is a single covalent bond or —CRₕ⁴Rₕ⁵—, wherein each of Rₕ⁴ and Rₕ⁵ is independently a hydrogen or an alkyl group having 1 to 4 carbon atoms;
A is a single covalent bond or CH₂O; and
R_{f} is —CFR_{f}¹CHFR_{f}², wherein R_{f}¹ is F, or CₖF₂ₖ₊₁, and k is an integer from 1 to 8; and wherein R_{f}² is F, a linear or branched CₚF₂ₚ₊₁, wherein p is an integer from 1 to 4, or R_{f}³O(R_{f}⁴O)ₘ—, wherein m is 0 or 1, and wherein R_{f}³ is CₙF₂ₙ₊₁, and n is an integer from 1 to 8, and R_{f}⁴ is C_{q}F_{2q}, wherein q is an integer from 1 to 4, provided that when R_{f}¹ is F and R_{f}² is F, then at least one of Rₕ¹, Rₕ² and Rₕ³ is CₓH₂ₓ₊₁.

6. The electrolyte composition according to claim 1, wherein the at least one cyclic carbonate comprises 4-(1,1,2,3,3,3-hexafluoropropyl)-1,3-dioxolan-2-one, 4-(1,1,2,3,3,3-hexafluoropropoxy)methyl)-1,3-dioxolan-2-one, or a combination thereof.

7. The electrolyte composition according to claim 1, wherein the at least one cyclic carbonate comprises 4,4-difluoro-1,3-dioxolan-2-one, 4-trifluoromethyl-1,3-dioxolan-2-one, fluoromethyl-1,3-dioxolan-2-one, 1′,1′,2′,2′-tetrafluoroethyl-1,3-dioxolan-2-one, or a combination thereof.

8. (canceled)

9. A lithium-containing electrochemical cell comprising a positive electrode, an electrolyte composition, and a negative electrode, wherein at least one of the positive electrode or the negative electrode comprises active lithium, and wherein the electrolyte composition comprises:
a solvent mixture comprising:
at least one cyclic carbonate; and
CF₃CFHCF₂OCH₃; and
at least one lithium salt dissolved in the solvent mixture, wherein if the electrolyte composition has flammable constituents, they are present in a combined amount of less than 5 percent by weight, and wherein the electrolyte composition is homogeneous and not ignitable.

10. The lithium-containing electrochemical cell according to claim 9, wherein an atomic ratio of F atoms to all monovalent atoms combined in the at least one highly fluorinated compound is at least 0.5.

11. The lithium-containing electrochemical cell according to claim 9, wherein the at least one cyclic carbonate comprises 4,4-difluoro-1,3-dioxolan-2-one, 4-trifluoromethyl-1,3-dioxolan-2-one, fluoromethyl-1,3-dioxolan-2-one, 1′,1′,2′,2′-tetrafluoroethyl-1,3-dioxolan-2- one, or a combination thereof.

12. (canceled)

13. A battery pack comprising at least one lithium-containing electrochemical cell according to claim 9.

14. A device comprising a battery pack according to claim 13.

15. The device according to claim 14, wherein the battery pack is electrically coupled to at least one of an electric motor or an electronic display.
